(19) United States
(12) Patent Application Publication
(10) Pub. No.: US 2002/0148147 A1
(43) Pub. Date: Oct. 17, 2002

(54) Display device having rotatable display object

(76) Inventor: Timothy Francis, Sussex, WI (US)

Correspondence Address: MICHAEL BEST & FRIEDRICH, LLP, 100 E WISCONSIN AVENUE, MILWAUKEE, WI, 53202, US

(21) Appl. No.: 10/080,937

(22) Filed: Feb. 22, 2002

Related U.S. Application Data
(60) Provisional application No. 60/270,795, filed on Feb. 23, 2001.

(51) Int. Cl. G09F 19/00

(52) U.S. Cl. 40/426

(57) ABSTRACT

A display device has a rotatable display object suspended in it. The display object is tethered at one end to a rotating motor shaft. The other end is suspended by a magnetic field between a magnet affixed to a support and another magnet affixed to the other end. When the shaft rotates, the display object also rotates. The display object can also be made to wobble, reciprocate or reverse directions.

### BACKGROUND OF THE INVENTION

This application relates to display devices, and more particularly to display having movable display objects.

Many types of display devices are used to capture the attention of the prospective customer. One way of capturing the attention is the use of lighting. Another way is to provide movement of some type.

### SUMMARY OF THE INVENTION

The present invention comprises an inexpensive display device in which the display object rotates and appears to be suspended in midair. The display device may also be made to wobble or reciprocate to attract the attention of a prospective customer. Nevertheless, the display device is relatively inexpensive to manufacture and operate.

In its basic form, the display device includes a motor having a rotatable output shaft, a display object having a first or upper end and a second or lower end, a tether interconnected between the motor shaft and the second end that is rotatable in response to the rotation of the motor shaft, a first magnet interconnected with the first end of the display object, and a second magnet affixed to a support that is disposed sufficiently close to the first magnet to create a magnetic field between the first magnet and the second magnet.

When the motor shaft is rotated, the tether and the display object are also rotated about an axis of rotation. The first and second magnets attract each other to suspend the display object in a fluid such as air. If the tether is made of a very thin linear element such as a thin wire or a light fishing line, the display object will appear to be freely suspended in the fluid.

Alternatively, the display object could extend horizontally or diagonally in the display device if the magnetic field is sufficiently strong to keep the tether taut.

Additional features may be added to the basic display device described above to achieve additional effects or to further attract the attention of a prospective customer. For example, the display object may be illuminated from above or the side, a fan could blow air onto the display object, or a spring or a cam may be used to cause the display object to wobble, oscillate or reciprocate. Additionally, the base or the entire display device could be slightly canted to cause the display object to either wobble while it rotates or to reverse direction. The display device may include a housing that is brightly colored or otherwise configured to attract attention.

These and other features of the present invention will be apparent to those skilled in the art from the detailed description of the invention and the drawings.

### BRIEF DESCRIPTION OF THE DRAWINGS

FIG. 1 is a perspective view of a first embodiment of the display device according to the present invention.

FIG. 2 is a perspective view of a variation of the first embodiment in which the display object is made to wobble.

FIG. 3 is a perspective view of a second embodiment of the display device.

FIG. 4 is an exploded view of an assembly that causes the display object to reciprocate along its axis of rotation.

### DETAILED DESCRIPTION

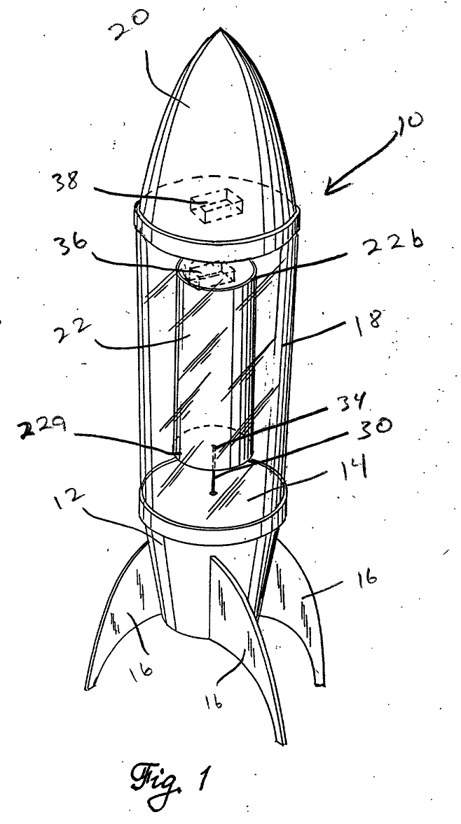

In FIG. 1, display device 10 has a housing shaped like a rocket ship. Of course, any other shaped housing may be used. The housing in FIG. 1 includes a base 12 having an upper surface 14, a plurality of supports 16, a transparent body 18, and a conical upper section 20. A display object 22 is suspended within midsection or body 18.

The display object could be any type of solid object to which attention is to be drawn, such as a consumer product like a beverage or other container.

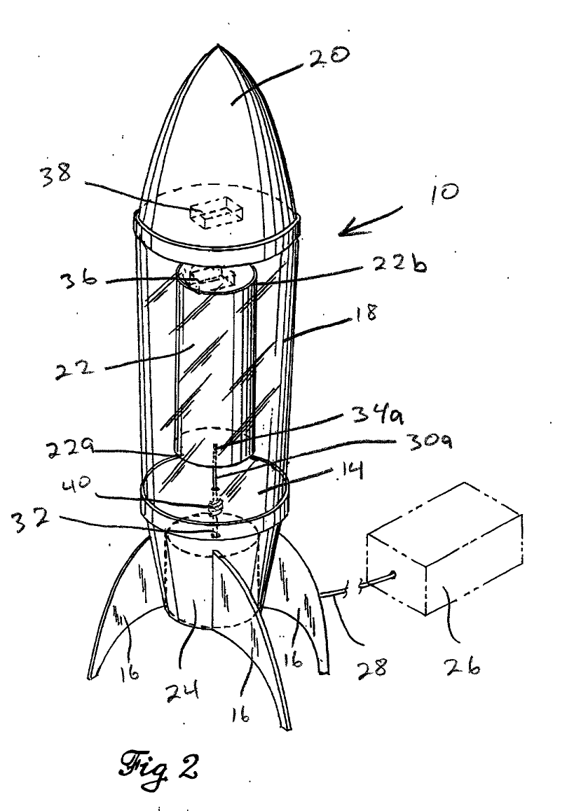

As best shown in FIG. 2, base 12 includes a small DC motor 24 that is powered by a power supply 26 via a power cord 28. Power supply 26 preferably includes an AC-to-DC transformer operable on line current such as 120 VAC. Of course, motor 24 could be battery-powered.

A tether 30 has one end interconnected with a rotatable motor shaft 32 (FIG. 2) and a second end 34 interconnected with a second or lower end 22a of display object 27. Tether 30 is preferably a monofilament light fishing line such as 2-pound test line, but a thin wire or other thin, linear elements could be used. Tether 30 rotates with motor shaft 32, thereby causing the display object to rotate.

A first or upper end 22b of display object 22 has interconnected thereto a relatively small permanent magnet 36, as shown in FIGS. 1 and 2. A second permanent magnet 38 is interconnected with a support (here, conical section 20) to enable second magnet 38 to be disposed sufficiently close to magnet 36 to create a magnetic field between the first and second magnets. Although any type of permanent magnets may be used, it is desirable that magnet 36 be relatively small and as light as possible to minimize the mass of display object 22. Magnet 38 preferably has a greater magnetic force then magnet 36. A suitable light permanent magnet that could be used for either or both of magnets 36 and 38 is a neodymium magnet. It is also possible to use an electromagnet for magnet 38, although that would substantially increase the cost of the display device.

FIG. 2 depicts a variation of the display device in which the display object 22 is made to wobble. To achieve this effect, a light spring 40 is interconnected between motor shaft 32 and tether 30a. One end of tether 30a is affixed to lower end 22a of the display object.

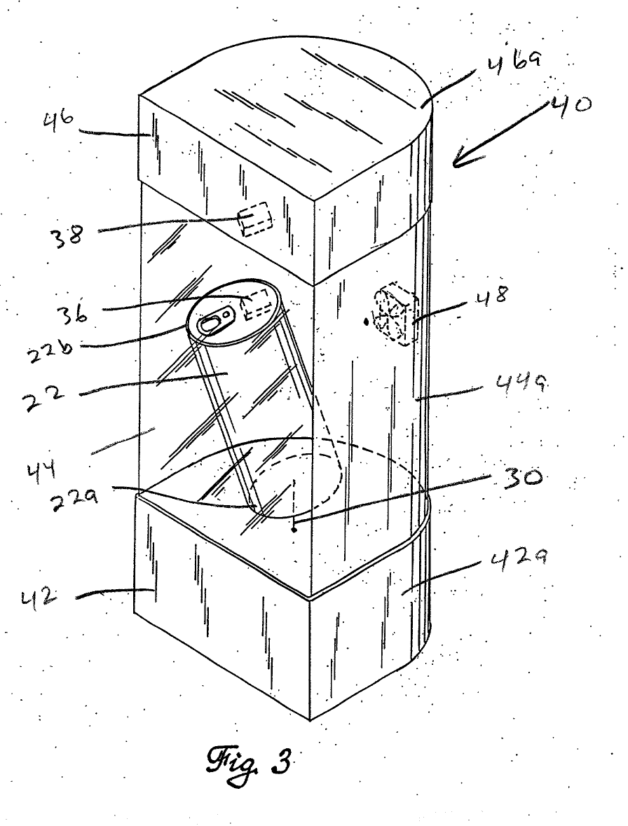

FIG. 3 depicts another embodiment of the present invention. In FIG. 3, as in all the Figures, corresponding components have been given the same part designations.

Referring to FIG. 3, display device 40 includes a housing having a base 42, a midsection 44, and an upper section 46, all having substantially flat front panels. In fact, the front panel of midsection 44 could be eliminated altogether.

Each of base 42, midsection 44, and upper section 46 has respective substantially cylindrical curved rear sections 42a, 44a and 46a. A small electric fan 48 is interconnected with section 44a. Fan 48 imparts an air flow onto the display object 22, causing the display object to slightly wobble or oscillate. Motor 24 (FIG. 2) is enclosed within base 42.

As evident from FIG. 3, display object 22 has its own longitudinal axis displaced from its axis of rotation. This is accomplished by placing magnet 36 off-center with respect to the upper end of display object 22b, as depicted in FIG. 3. Displacement of magnet 36 causes display object 22 to rotate in a slightly canted fashion.

Other effects may be readily achieved in any of the display devices described herein. For example, motor 24 could be a reversible motor, causing the display object to alternately rotate in both directions. The motor could alternatively be a stepper motor or could be an inexpensive motor having an erratic output, both of which would achieve special effects that may be desirable in some applications. A programmable controller could be used to sequence the effects or to otherwise control movement and illumination of the display object.

Alternately, the base of the display device could be slightly non-horizontal or canted, thereby causing tether 30 to twist upon rotation of the motor shaft. This twisting would cause the display object to rotate in a first direction, momentarily stop, and rotate in the opposite direction while the tether unwinds. A similar effect is achieved when the motor is first turned on.

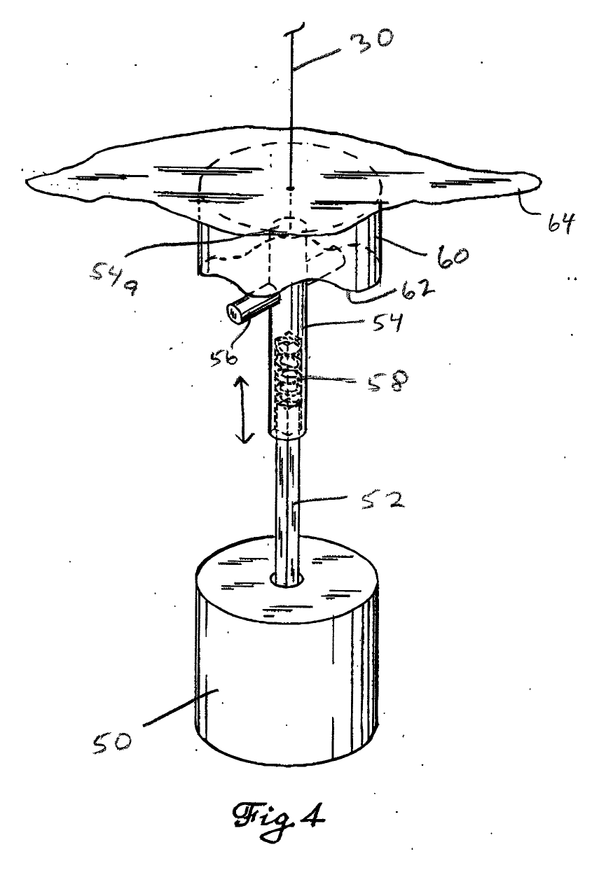

FIG. 4 depicts an assembly that is used to achieve another special effect, namely reciprocation of the display object in a direction that is substantially parallel to its axis of rotation. In FIG. 4, motor 50 includes a squared or other non-circular output shaft 52 that receives a slidable rod 54 having a corresponding interior slot. Attached to rod 54 is a transverse cam follower member 56. A spring 58 is disposed in the slot between the end of motor shaft 52 and rod 54.

A cylindrical member 60 has a cam surface 62 on one end thereof. Transverse member 56 rides on cam surface 62, as described below. Cylindrical member 60 is affixed to a stationary base 64, which forms the base or lower surface of the display device's midsection as discussed above in connection with the other embodiments. The upper end 54a of rod 54 is interconnected with tether 30.

The apparatus in FIG. 4 operates in the following manner. When motor shaft 52 rotates, rod 54 keyed thereto rotates with the motor shaft. Spring 58 tends to bias rod 54 in the upward direction. Upon rotation of rod 54, transverse member 56 also rotates, following cam surface 62. Since cylindrical member 60 is affixed to the base and is stationary, rod 54 is forced to move in a direction parallel to its axis of rotation as cam follower 56 follows cam surface 62. Reciprocation of rod 54 causes tether 30 attached thereto to also reciprocate in the axial direction, thereby causing display object 22 to reciprocate. Of course, it is readily apparent to those skilled in the art that other apparatus may be used to cause the display object 22 to reciprocate.

While several embodiments of the invention have been shown and described, alternate embodiments will be apparent to those skilled in the art and are within the intended scope of the present invention.

1. A display device, comprising:
a motor having a rotatable output shaft;
a display object having a first and a second end;
a tether, interconnected between said motor shaft and said second end, that is rotatable in response to the rotation of said motor shaft;
a first magnet interconnected with said first end; and
a second magnet, affixed to a support, that is disposed sufficiently close to said first magnet to create a magnetic field between said first magnet and said second magnet,
whereby the rotation of said motor shaft rotates said tether and said display object about an axis of rotation while said magnetic field suspends the display object in a fluid.

2. The display device of claim 1, further comprising:
a spring interconnected between said motor shaft and said second end.

3. The display device of claim 1, wherein said first magnet intersects said axis of rotation.

4. The display device of claim 1, wherein said first magnet does not intersect said axis of rotation.

5. The display device of claim 1, further comprising:
a fan that causes air flow onto said display object.

6. The display device of claim 1, further comprising:
a cam surface, disposed between said motor shaft and said tether, that is rotatable with one of said motor shaft and said tether; and
a cam follower, disposed between said motor shaft and said tether, that engages said cam surface and that is rotatable with the other of said motor shaft and said tether;
whereby the rotation of said motor shaft causes the relative position between said cam surface and said cam follower to change, thereby reciprocating said display object while said display object rotates.

7. The display device of claim 1, wherein said tether comprises a monofilament fishing line. Not limited to monofilament.

8. The display device of claim 1, wherein the magnetic force of said second magnet is greater than the magnetic field of said first magnet.
